(19) United States
(12) Patent Application Publication
(10) Pub. No.: US 2022/0138515 A1
(43) Pub. Date: May 5, 2022

(54) Image Data Mapping

(71) Applicant: Hewlett-Packard Development Company, L.P., Spring, TX (US)

(72) Inventors: Joan Solans Marsa, Sant Cugat del Valles (ES); Marina Cantero Lazaro, Sant Cugat del Valles (ES); Jordi Vilar Benito, Sant Cugat del Valles (ES); Raul Quiles Garcia, Sant Cugat del Valles (ES)

(73) Assignee: Hewlett-Packard Development Company, L.P., Spring, TX (US)

(21) Appl. No.: 17/419,367

(22) PCT Filed: Jul. 19, 2019
(86) PCT No.: PCT/US2019/042554

§ 371 Date: Jun. 29, 2021

(51) Int. Cl. G06K 15/02

(52) U.S. Cl. CPC G06K 15/027; G06K 15/1803; G06K 15/1822

(57) ABSTRACT

Image data mapping is described in which a patch image with patch image parameters including a patch image identifier relating to the patch image is generated; the production of the patch image on a recorded medium in a first printing environment is initiated; the produced patch image with the patch image parameters to determine patch image data of the produced patch image is analysed; and the patch image data is mapped to the patch image identifier to generate an information resource.

### BACKGROUND

Images are processed for use with computing machines, such as an image production apparatus. An image production apparatus, for example, may use control data based on processed image data to reproduce a physical representation of an image on a recorded medium including, for example, cellulose paper, metal, plastic, fabric, and the like.

An image production apparatus may be provided in a printing environment which may further comprise other apparatus that assist in a printing operation, for example, a print server and/or a processor or a plurality of processors. Each printing environment may have its own colour profile provided by the image production apparatus manufacturer, which is commonly in the form of an International Colour Consortium (ICC) profile. Some printing environments allow for the generation of custom colour profiles.

### BRIEF DESCRIPTION OF THE DRAWINGS

FIG. 1 is a schematic diagram showing components of an image processing system according to an example;

FIG. 2 is a flow diagram showing a method of generating an information resource according to an example;

FIG. 3 is a schematic diagram showing components of generating a patch image according to an example;

FIG. 4 is a flow diagram showing the generation of a patch image according to an example;

FIG. 5 is a schematic diagram showing components of producing a patch image according to an example;

FIG. 6 is a flow diagram showing the production of a patch image according to an example;

FIG. 7 is a schematic diagram showing components for analyzing a produced patch image according to an example;

FIG. 8 is a flow diagram showing the analysis of a produced patch image according to an example;

FIG. 9 is a schematic diagram showing components for mapping a patch image identifier and patch image data according to an example;

FIG. 10 is a flow diagram showing the mapping of a patch image identifier and patch image data according to an example;

FIG. 11 is a schematic diagram showing components for calibrating a second printing environment according to an example;

FIG. 12 is a flow diagram showing the calibration of a second printing environment according to an example;

FIG. 13 is an example of a computer readable medium comprising instructions to map patch image data to patch image parameters according to an example.

### DETAILED DESCRIPTION

An image production apparatus such a printer in a first printing environment may have a pre-installed ICC colour profile to allow the processing of colours which are defined as a combination of variables in a particular colour space or colour model. For example, in a cyan, magenta, yellow and black (CMYK) colour model, a colour may be defined by four variables to represent different quantities of cyan, magenta, yellow and black (key) colorant or ink. In a red, green, blue (RGB) colour model, a colour may be defined by three variables to represent different quantities of red, green and blue light.

An image production apparatus may be provided with custom colour profiles having custom spot colours with a custom colour identifier such as a custom name having been created to identify each custom spot colour. The custom colour may be defined in the first printing environment using a colour model such as, for example, CMYK and/or RGB. These custom colour profiles are created within the first printing environment and may become the reference for all subsequent prints in the first printing environment. Installing a second printing environment which may include a second image production apparatus with its own colour profile which may be different to the first printing environment may then involve calibration of the second printing environment with the custom colour profile of the first printing environment in order for the second printing environment to produce the same custom colours and match the custom colours that are output by the first printing environment.

Examples described herein relate to the generation of patch image data relating to patch images produced in the first printing environment, to generate an information resource comprising a patch image identifier mapped to the patch image data. This information resource may be used to calibrate the second printing environment with the custom colour profile of the first printing environment to allow efficient and reliable emulation of spot colour images identified by their respective patch image identifiers from a first printing environment to a second printing environment.

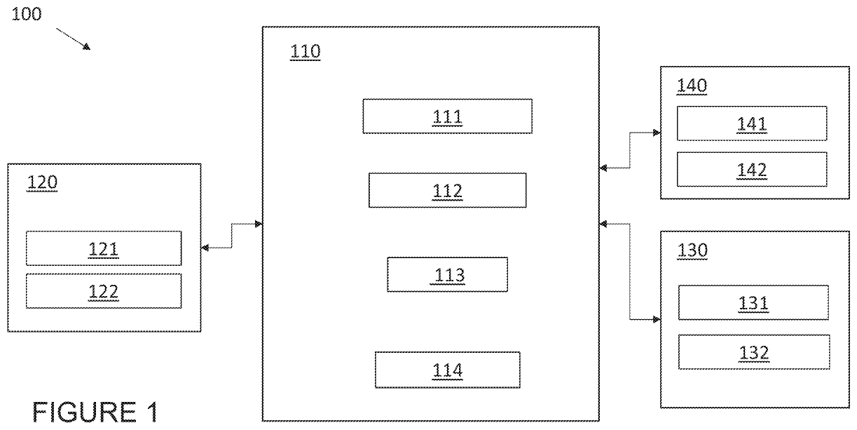

Referring to FIG. 1, there is shown an example of an image processing system 100.

In this example, the image processing system 100 comprises a controller 110. The controller 110 may comprise a plurality of components, some of which are described below according to an example. The controller may be a programmable logic device (PLD) or other computing device that can carry out instructions. The controller may include multiple processing elements that are integrated in a single device as described in the example below or distributed across devices.

The controller 110 of the image processing system 100 may comprise a data input/output unit 111 to receive input data from external components including, but not limited to, a first printing environment 120. The data input/output unit 111 may also output data from the controller to other external components including, but not limited to, a second printing environment 130 and an image analysing device 140.

The controller 110 of the image processing system 100 may further comprise a user interface 112 to allow interaction and/or manipulation of any data within the controller. The user interface may allow interaction and/or manipulation of any data received, or to be sent, from the controller 110 via the data input/output unit 111. The user interface may include a display unit to display data and/or user input devices (not shown) to allow a user to interact with the image processing system 100.

The controller 110 of the image processing system 100 may further comprise a processor 113 to manage all the components within the controller 110, and process all data flow between the components within the controller 110.

The controller 110 of the image processing system 100 may further comprise a storage or memory unit 114 to store any data or instructions which may need to be accessed at a later stage. The time extent to which the data is stored in the storage unit 114 may vary depending on the various data requirements of the controller 110.

The image processing system 100 as shown in FIG. 1 further comprises the first printing environment 120, and the second printing environment 130. The image processing system 100 may comprise multiple printing environments, therefore it is not limited to a first and second printing environment as is described in this example. Furthermore, the first printing environment 120 and the second printing environment 130 (or any additional printing environment) may include components that are the same version or different versions of each other. The components of each printing environment are therefore not limited to the example components as described below.

The first printing environment 120 of the image processing system 100 may comprise a processor 121 to receive and process data from the controller 110. The first printing environment 120 also comprises an image production unit 122. The image production unit 122 may use control data based on processed image data to reproduce a physical representation of an image on a recorded medium including, for example, cellulose paper, metal, plastic, fabric, and the like.

The second printing environment 130 of the image processing system 100 may comprise a processor 131 to receive and process data from the controller 110. The second printing environment 130 also comprises an image production unit 132. The image production unit 132 may use control data based on processed image data to reproduce a physical representation of an image on a recorded medium including, for example, cellulose paper, metal, plastic, fabric, and the like.

The image processing system 100 as shown in FIG. 1 further comprises an optical device 140. The optical device 140 comprises a processor 141 and a sensor 142. The processor 141 may process measurements from the sensor 142. The sensor 142 may measure spectral reflectance of an image on a recorded medium and detect the intensity of each wavelength of visible light from the image. The processor 141 may determine and produce image data representing the colour of the image, based on the levels of each wavelength of visible light reflected from the image on a recorded medium. The produced image data may, as an example, be represented in the CIE L*a*b* (CIELAB) colour space, defined by the International Commission on Illumination (CIE). The CIELAB colour space includes the range of colours, or the colour gamut, of at least the RGB and CMYK colour models. Other colour spaces comprising the gamut of at least the RGB and CMYK colour models may be used to represent the produced image data, therefore the produced image data is not limited to being represented in the CIELAB colour space. As an example, the optical device 140 may be a spectrophotometer or a colorimeter. As an example, the optical device 140 may be located in the first printing environment 120 and/or the second printing environment 130.

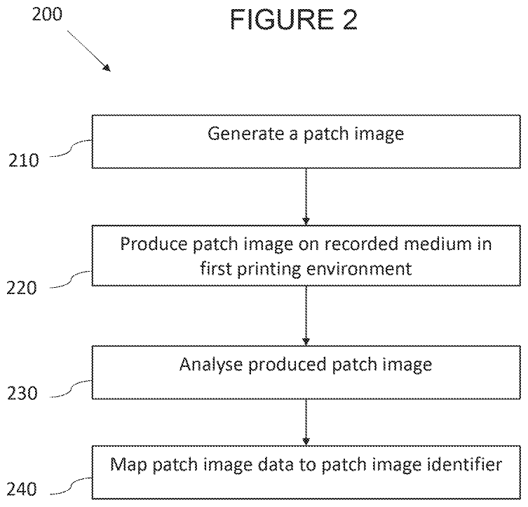

Referring to FIG. 2, there is shown a method 200 of generating an information resource based on the colour profile of a first printing environment. The method 200 starts with generating 210 a patch image of at least one spot colour in the first printing environment. If there are a plurality of spot colours, the patch image may be in the form of a colour chart. Block 220 of method 200 further comprises producing the patch image on a recorded medium in the first printing environment 120. Block 230 comprises analysing the produced patch image via the optical device 140. Block 240 comprises mapping a patch image identifier with patch image data to generate the information resource.

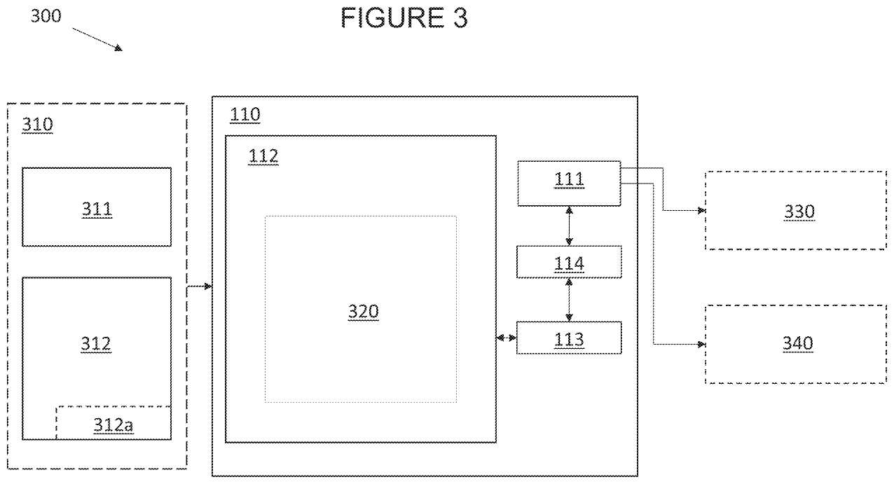

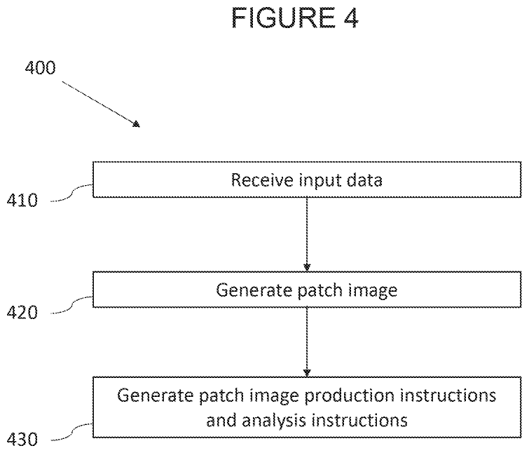

FIGS. 3 and 4 provide further details in reference to block 210 of method 200.

Referring to FIG. 3 and flow diagram 400 of FIG. 4, block 410 of flow diagram 400 comprises receiving, by controller 110 via the input/output unit 111, input data 310 comprising a patch image definition in a first colour model 311, and patch image parameters 312. The patch image definition in a first colour model 311 may be represented, in one example, in the RGB colour model. The patch image definition in the first colour model 311 is not limited to being represented in the RGB colour model and may be represented by any colour model capable of generating a patch image on the user interface 112 of the controller 110. The patch image parameters 312 include patch image identifier(s) 312a which, in one example, is the name of each spot colour which forms the patch image. The name is a type of unique identifier and other types of unique identifier for the particular patch image may be used in other examples. The patch image parameters 312 may further include parameters of the patches that form the patch image such as the dimensions of the patches, the number of patches, and the location of the patches in the patch image. The patch image parameters 312 may be stored in the storage unit 114.

Block 420 of flow diagram 400 of FIG. 4 comprises generating a patch image 320. The controller 110 may receive a patch image definition in a first colour model 311 and patch image parameters 312 via the data input/output unit 111 of the controller 110, and the patch image 320 may be generated in the user interface 112 of the controller 110. The generated patch image 320 may comprise a patch or a plurality of patches each comprising a sample of a spot colour. As an example, the generated patch image 320 may be in a Portable Document Format (PDF) or Encapsulated PostScript (EPS) file format. Furthermore, the patch/patches of the generated patch image 320 may have parameters as defined by the patch image parameters 312.

Block 430 of flow diagram 400 of FIG. 4 comprises generating patch image production instructions 330 and optical device analysis instructions 340. The controller 110 may process the generated patch image 320 via the processor 113 and cause patch image production instructions 330 to be sent via the data input/output unit 111 to the first printing environment 120. The patch image production instructions 330 may be in a data format which is compatible with the first printing environment 120, and when processed by the processor 121 of the first printing environment 120, may instruct the image production unit 122 of the first printing environment 120 to produce the generated patch image 320 on a recorded medium. Furthermore, the controller 110 may process the generated patch image 320 and the patch image parameters 312 to generate optical device analysis instructions 340 to be sent via the data input/output unit 111 to the optical device 140. The optical device analysis instructions 340 may be in a data format which is compatible with the optical device 140, and when processed by the processor 141 of the optical device 140, may instruct the optical device 140 to begin measuring each patch of the generated patch image 320 on a recorded medium.

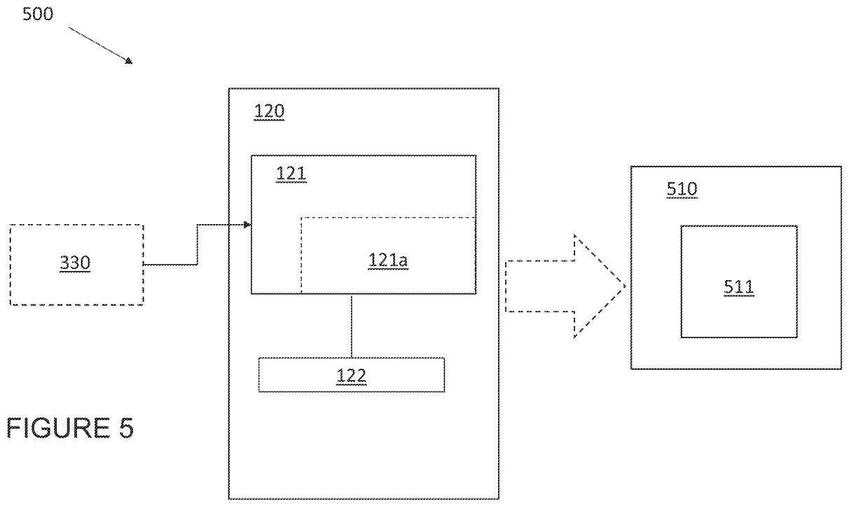

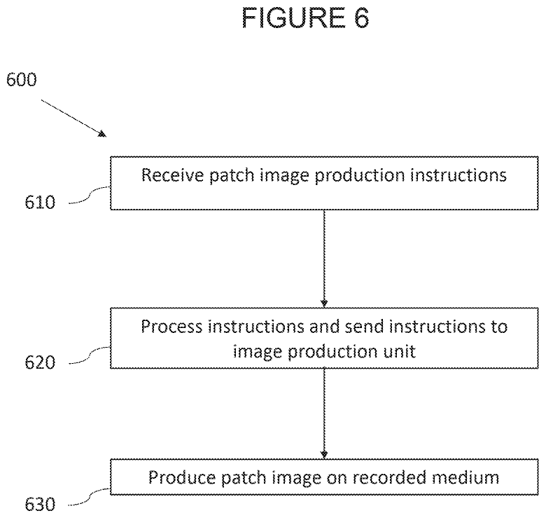

FIGS. 5 and 6 provide further details in reference to block 220 of method 200.

Referring to FIG. 5 and flow diagram 600 of FIG. 6, block 610 of flow diagram 600 comprises receiving, by the first printing environment 120, the patch image production instructions 330 sent via the data input/output unit 111 of controller 110. The patch image production instructions 330 may be in a data format compatible with the printing environment.

Block 620 of flow diagram 600 of FIG. 6 comprises processing the patch image production instructions 330 via the processor 121 of the first printing environment 120 and translating the patch image production instructions 330 into a patch image definition in a second colour model 121a, and sending the patch image definition in the second colour model 121a to the image production unit 122 of the first printing environment 120. The patch image definition in the second colour model 121a may be represented in the CMYK colour model. The patch image definition in the second colour model 121a is not limited to being represented in the CMYK colour model and may be represented by any colour model capable of generating a patch image on the recorded medium 510. Example 1 below is an example of a patch image with patch image identifier 312a “PANTONE Warm Red” defined in the CMYK colour model. PANTONE Warm Red may be a custom spot colour in a custom colour profile.

```
<rdf:li rdf:parseType=“Resource”>
  <xmpG:swatchName>PANTONE Warm Red
  CVC</xmpG:swatchName>
  <xmpG:type>SPOT</xmpG:type>
  <xmpG:tint>100.000000</xmpG:tint>
  <xmpG:mode>CMYK</xmpG:mode>
  <xmpG:cyan>0.000000</xmpG:cyan>
  <xmpG:magenta>79.000002</xmpG:magenta>
  <xmpG:yellow>91.000003</xmpG:yellow>
  <xmpG:black>0.000000</xmpG:black>
</rdf:li>
```

### Example 1

Block 630 of flow diagram 600 of FIG. 6 comprises producing a patch image 511 on the recorded medium 510 via the image production unit 122 of the first printing environment 120. The patch image 511 is therefore printed out onto the recorded medium 510 which may be representative of a medium such as paper that may be normally used to print jobs that include the spot colours in the first printing environment, which are to be emulated in the second printing environment.

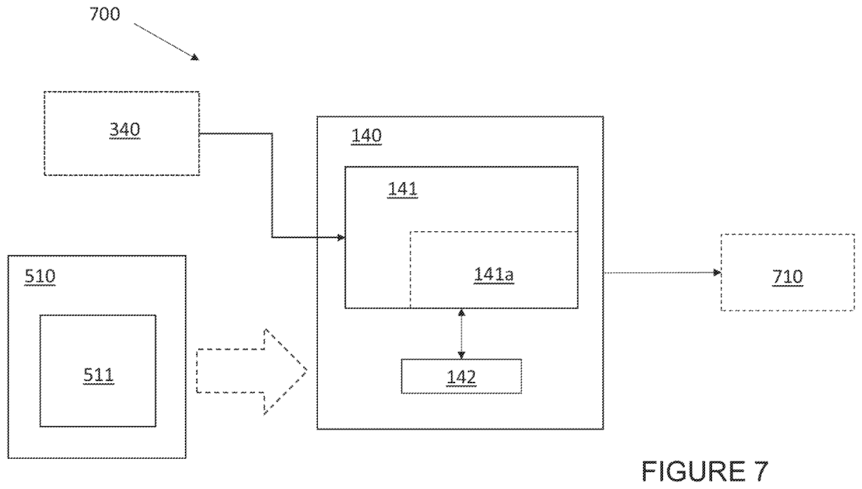

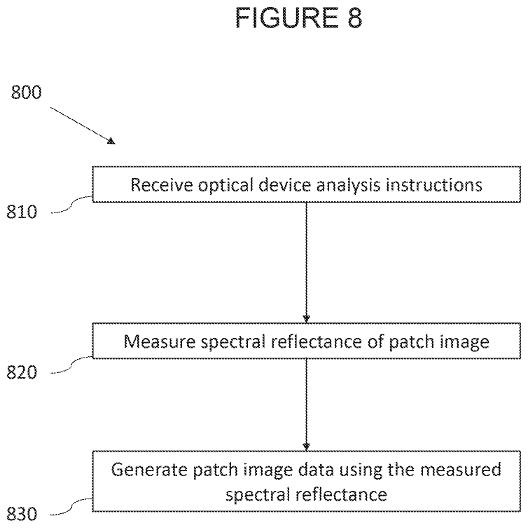

FIGS. 7 and 8 provide further details in reference to block 230 of method 200.

Referring to FIG. 7 and flow diagram 800 of FIG. 8, block 810 of flow diagram 800 comprises receiving, by the optical device 140, optical device analysis instructions 340 sent via the data input/output unit 111 of controller 110. The optical device instructions 340 may be in a data format which is compatible with the optical device 140. The optical device analysis instructions 340 may comprise instructions to measure the spectral reflectance of the patch/patches of the produced patch image 511 on the recorded medium 510. The instructions may comprise the physical start location for measurement of the produced patch image 511, the physical end location for measurement of the patch image 511, and the physical location(s) of the patch/patches of the produced patch image 511. The processor 141 of the optical device 140 processes the optical device analysis instructions 340 and produces an optical device job 141a. The optical device job 141a may comprise instructions to direct the sensor 142 of the optical device 140 along the produced patch image 511 on the recorded medium 510. The instructions to direct the sensor 142 may be based on the optical device analysis instructions 340.

Block 820 of the flow diagram 800 of FIG. 8 comprises measuring the spectral reflectance of the patch/patches of the produced patch image 511 on the recorded medium 510 via the sensor 142 of the optical device 140. The sensor 142 may follow the measurement instructions of the optical device job 141a. The sensor 142 may detect the levels of each wavelength of visible light reflected from the patch/patches of the produced patch image 511 and send the measurement data to the processor 141 of the optical device 140.

Block 830 of the flowchart 800 of FIG. 8 comprises the generation of patch image data. The processor 141 of the optical device 140 may receive the measurement data produced by the sensor 142 and process the measurement data to generate patch image data 710. The patch image data 710 comprises a definition of the produced patch image 511 represented in a first colour space. The first colour space may be the CIELAB colour space. The patch image data 710 is not limited to being represented in the CIELAB colour space and may be represented by any colour space comprising the gamuts of at least the RGB and CMYK colour models. The patch image data 710 may be output to the controller 110. Example 2 below is an example of patch image data 710 in the CIELAB colour space of a produced patch image 511 with patch identifier 312a “PANTONE Warm Red” from Example 1.

```
<rdf:li rdf:parseType=“Resource”>
  <xmpG:swatchName>PANTONE Warm Red
  C</xmpG:swatchName>
  <xmpG:type>SPOT</xmpG:type>
  <xmpG:tint>100.000000</xmpG:tint>
  <xmpG:mode>LAB</xmpG:mode>
  <xmpG:L>58.823528</xmpG:L>
  <xmpG:A>70</xmpG:A>
  <xmpG:B>51</xmpG:B>
</rdf:li>
```

### Example 2

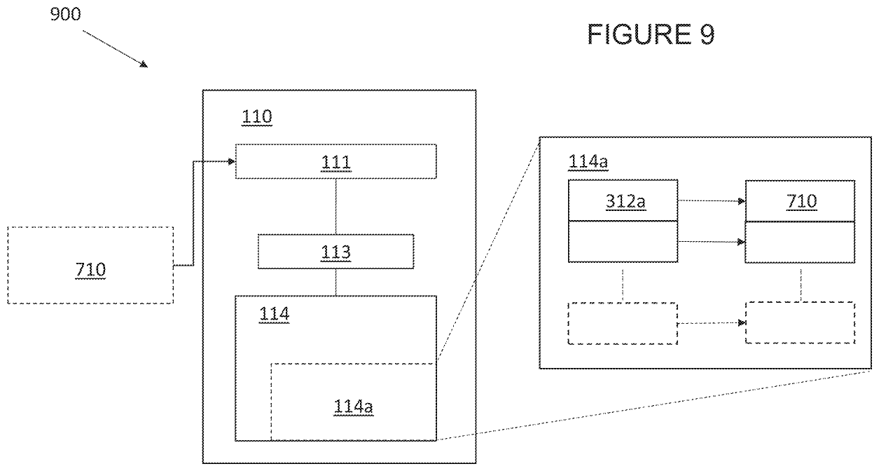

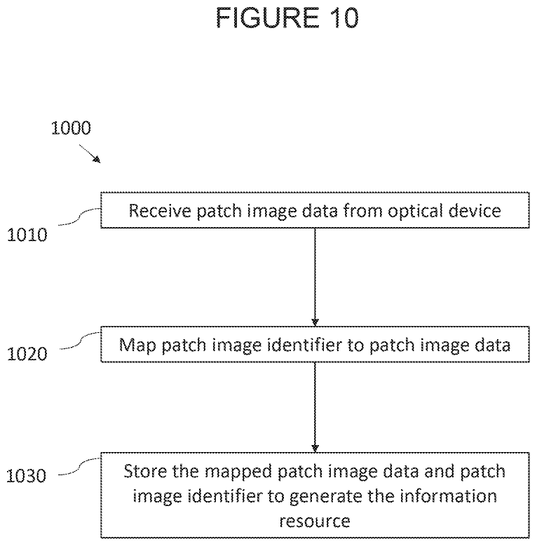

FIGS. 9 and 10 provide further details in reference to block 240 of method 200.

Referring to FIG. 9 and flow diagram 1000 of FIG. 10, block 1010 of the flow diagram 1000 of FIG. 10 comprises receiving the patch image data 710 from the optical device 140 via the data input/output unit 111 of the controller 110.

Block 1020 of the flow diagram 1000 of FIG. 10 comprises mapping the patch image identifier 312a to the patch image data 710. The processor 113 may retrieve the stored patch image identifier(s) from the storage unit 114. The processor may further process the patch image data 710 received from the optical device 140 via the data input/output unit 111 of the controller 110, mapping the stored patch image identifier(s) 312a with the corresponding patch image data 710. The mapping may comprise associating the patch image identifier(s) of the individual patch/patches of the produced patch image 511 on the recorded medium 510, with the patch image data 710 of the individual patch/patches of the produced patch image 511 on the recorded medium 510.

Block 1030 of the flow diagram 1000 of FIG. 10 comprises storing the mapped patch image identifier(s) 312b and patch image data 710 to generate an information resource 114a within the storage unit 114 of the controller 110. In an example, the information resource 114a may be a database within the storage unit 114. In other examples, the information resource 114a may be a library, look up table, or other resource that contains information relating to the patch image data 710 and the patch image identifier 312a. The processor 113 may cause the mapped patch image identifier(s) 312b and patch image data 710 to be stored in the storage unit 114 to generate the information resource 114a. FIG. 9 shows an example of the information resource 114a within the storage unit 114 comprising the mapped patch image identifier(s) 312a with the corresponding patch image data 710.

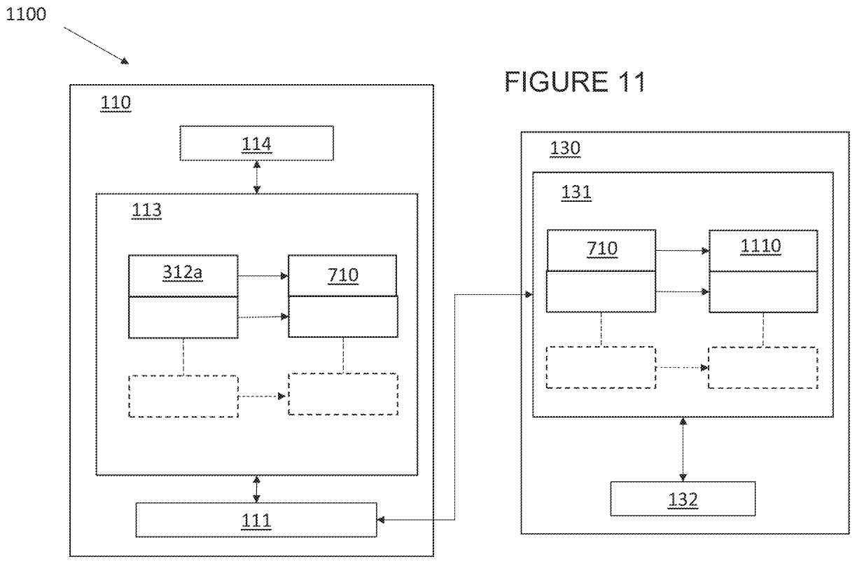

Referring to FIG. 11, there is shown a schematic diagram showing components for calibrating a second printing environment using the mapped patch image identifier(s) 312a and patch image data 710.

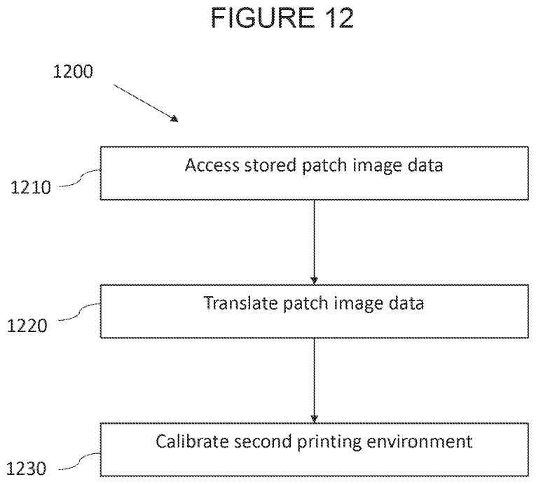

Referring to FIG. 11 and flow diagram 1200 of FIG. 12, block 1210 comprises accessing, by the processor 113, the stored mapped patch image identifier 312a and patch image data 710 from information resource 114a of the storage unit 114. The processor 113 may process the mapped patch image identifier 312a and patch image data 710 and output, via the data input/output unit 111, the mapped patch image identifier 312a and patch image data 710 to the second printing environment 130.

Block 1220 of the flow diagram 1200 of FIG. 12 comprises translating the patch image data 710. The processor 131 of the second printing environment may receive the mapped patch image identifier 312a and patch image data 710. The processor 131 may then translate the patch image data 710 to a translated patch image data 1110 comprising a definition of the produced patch image 511 in a third colour model. The translated patch image data 1110 may be represented in the CMYK colour model. The translated patch image data 1110 is not limited to being represented in the CMYK colour model and may be represented by any colour model capable of generating a patch image on a recorded medium. FIG. 11 further shows an example of the processor 131 comprising the translated patch image data 1110.

Block 1230 of the flow diagram 1200 of FIG. 12 comprises calibrating the second printing environment 130 with the translated patch image data 1110. The processor 131 of the second printing environment 130 may process the translated patch image data 1110 so that any future instructions sent to the image production unit 132 in the second printing environment may produce images based on the translated patch image data 1110. In an example, any future image produced on a recorded medium by the image production unit 132, may have their colour(s) produced corresponding to the translated patch image data 1110, which in turn corresponds to the patch image data 710 of the produced patch image 511. This may occur where at least one colour in the future image relates to the spot colour in the produced patch image 511.

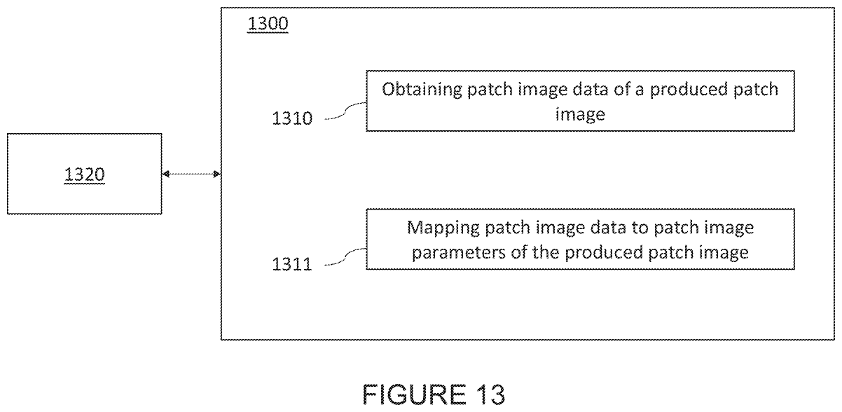

FIG. 13 shows a memory 1300, which is an example of a computer readable medium storing instructions 1310, 1311, that, when executed by a processor 1320 communicably coupled to a computing device, may cause the processor 1320 to generate an information resource comprising a patch image identifier mapped to the patch image data in accordance with any of the examples described above. The computer readable medium 1300 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

In addition to the examples described in detail above, various features described herein may be modified and/or combined with additional features, and the resulting additional examples may be implemented without departing from the scope of the system of the present disclosure, as this specification merely sets forth some of the many possible example configurations and implementations for the claimed solution.

1. A method comprising:
generating a patch image with patch image parameters including a patch image identifier relating to the patch image;
initiating the production of the patch image on a recorded medium in a first printing environment;
analysing the produced patch image with the patch image parameters to determine patch image data of the produced patch image; and
mapping the patch image data to the patch image identifier to generate an information resource.

2. The method according to claim 1, wherein generating the patch image comprises:
receiving input data comprising a definition of the patch image in a first colour model and the patch image parameters;
generating the patch image based on the input data with the patch image parameters;
generating patch image production instructions to produce the patch image on a recorded medium;
generating optical device instructions to perform the analysis on the produced patch image based on the patch image parameters;

3. The method according to claim 2, wherein initiating the production of the patch image comprises:
receiving the patch image production instructions by the first printing environment;
translating the patch image production instructions into a patch image definition in a second colour model; and
producing the patch image on the recorded medium in the first printing environment.

4. The method according to claim 2, wherein analysing the produced patch image comprises:
receiving the optical device instructions by an optical device;
generating an optical device job based on the optical device instructions;
measuring the spectral reflectance of the produced patch image by a sensor; and
outputting the patch image data.

5. The method according to claim 1, wherein the patch image data comprises a definition of the produced patch image in a first colour space.

6. The method according to claim 5, wherein mapping the patch image data to the patch image identifier comprises:
receiving the patch image data comprising the definition of the produced patch image in the first colour space;
mapping the patch image data of the produced path image to the patch image identifier; and
storing the mapped patch image data and patch image identifier to generate the information resource.

7. The method according to claim 6, further comprising:
accessing the stored patch image data and patch image identifier from the information resource;
translating the patch image data from the first colour space to a third colour model of a second printing environment;
sending calibration instructions comprising the translated patch image data and patch image identifier to the second printing environment; and
calibrating the second printing environment with the translated patch image data.

8. The method according to claim 1, wherein the patch image comprises a spot colour or a plurality of spot colours, each having their own patch image identifier, and wherein the patch image identifier is the name associated with the spot colour.

9. The method according to claim 8, wherein the spot colour or plurality of spot colours are defined in the first printing environment.

10. An image processing system comprising a controller to:
obtain patch image data of a produced patch image in a first printing environment;
generate an information resource by mapping the patch image data to a patch image identifier of the produced patch image.

11. The system according to claim 10, wherein a spectrophotometer or colorimeter is used to obtain patch image data of the produced patch image.

12. The system according to claim 10, wherein the patch image data comprises the definition of the produced patch image in a first colour space.

13. The method according to claim 12, wherein generating the information resource comprises:
receiving the patch image data comprising the definition of the produced patch image in the first colour space;
mapping the patch image data of the produced patch image to the patch image identifier; and
storing the mapped patch image data and patch image identifier in a database.

14. The system according to claim 10, wherein the patch image comprises a spot colour or a plurality of spot colours, each with their own unique patch image identifier.

15. A non-transitory computer-readable medium comprising instructions, which when executed on a computing device, cause the computing device to carry out the steps of:
obtaining patch image data of a produced patch image in a first printing environment;
mapping the patch image data to patch image parameters of the produced patch image.
